(19) United States
(12) Patent Application Publication
(10) Pub. No.: US 2016/0086063 A1
(43) Pub. Date: Mar. 24, 2016

(54) IMAGE FORMING DEVICE AND METHOD AND NON-TRANSITORY COMPUTER READABLE MEDIUM

(71) Applicant: FUJI XEROX CO., LTD., Tokyo (JP)

(72) Inventors: Junichi HORII, Kanagawa (JP); Koji NISHIYAMA, Kanagawa (JP)

(73) Assignee: FUJI XEROX CO., LTD., Tokyo (JP)

(21) Appl. No.: 14/681,191

(22) Filed: Apr. 8, 2015

(30) Foreign Application Priority Data
Sep. 22, 2014 (JP) 2014-192937

(51) Int. Cl. G06K 15/02

(52) U.S. Cl. CPC G06K 15/1813; G06K 15/1809; G06K 15/1843

(57) ABSTRACT

An image forming device includes a receiver, a generator, and a controller. The receiver receives, from an external device, print instruction information including print data described in a page description language and a first image generated from the print data by the external device. The generator generates a second image from the print data included in the print instruction information. The controller compares the first image and the second image with each other and causes a display to display misregistration of the first image and the second image as a comparison result.

### CROSS-REFERENCE TO RELATED APPLICATIONS

This application is based on and claims priority under 35 USC 119 from Japanese Patent Application No. 2014-192937 filed Sep. 22, 2014.

### BACKGROUND

(i) Technical Field

The present invention relates to an image forming device and method and a non-transitory computer readable medium.

(ii) Related Art

Generally, print data sent from a processing device, such as a personal computer or a workstation, to a printer, is written in a page description language (PDL), such as a portable data format (PDF) or PostScript (registered). PDL data is converted into raster format (for example, bitmap format) image data (raster data) by a data processing device called a raster image processor (RIP). The printer then prints an image represented by the raster data.

### SUMMARY

According to an aspect of the invention, there is provided an image forming device including a receiver, a generator, and a controller. The receiver receives, from an external device, print instruction information including print data described in a page description language and a first image generated from the print data by the external device. The generator generates a second image from the print data included in the print instruction information. The controller compares the first image and the second image with each other and causes a display to display misregistration of the first image and the second image as a comparison result.

### BRIEF DESCRIPTION OF THE DRAWINGS

An exemplary embodiment of the present invention will be described in detail based on the following figures, wherein:

FIG. 1 is a block diagram illustrating an example of an image forming system according to an exemplary embodiment of the invention;

FIG. 2 is a block diagram illustrating an example of an image forming device according to an exemplary embodiment of the invention;

FIG. 3 is a block diagram illustrating an example of a terminal device;

FIG. 4 illustrates an example of a screen for setting image generating conditions;

FIG. 5 illustrates an example of a list of items of print data;

FIG. 6 illustrates an example of a screen on which images for comparison are displayed;

FIGS. 7A and 7B illustrate examples of comparison results;

FIG. 8 is a flowchart illustrating an example of processing executed in a terminal device; and

FIG. 9 is a flowchart illustrating an example of processing executed in the image forming device.

### DETAILED DESCRIPTION

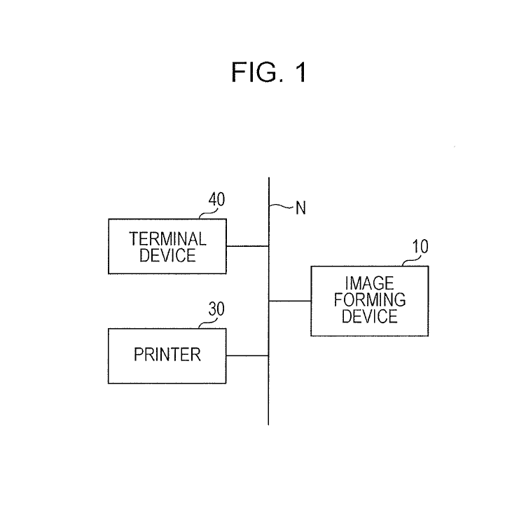

FIG. 1 illustrates an example of an image forming system according to an exemplary embodiment of the invention. The image forming system includes, for example, an image forming device 10, a printer 30, and a terminal device 40. The image forming device 10, the printer 30, and the terminal device 40 are connected to a communication channel N, such as a network. In the example shown in FIG. 1, one printer 30 and one terminal device 40 are connected to the communication channel N. However, the number of printers 30 and the number of terminal devices 40 are not restricted, and two or more printers 30 and terminal devices 40 may be disposed.

Each of the image forming device 10 and the terminal device 40 has a function of sending data to another device and a function of receiving data from another device. For example, the image forming device 10 has a function of receiving print data from the terminal device 40 and a function of converting the print data into data that is handled by the printer 30 (raster data). The printer 30 is, for example, an electrophotographic printer. The printer 30 prints an image based on raster data on a recording medium, such as a recording sheet, by using a color material (recording material), such as toner or ink. The printer 30 may be a printer that forms images by using a method other than the electrophotographic system. The image forming device 10 and the printer 30 may be formed integrally.

Print data is data indicating a set of drawing commands written in a PDL and used for printing images of one or more pages. A PDL is a language, such as PDF or PostScript (registered). Hereinafter, print data written in a PDL will be referred to as “PDL data”.

An image of a page to be printed is constituted by drawing objects, which are image elements. A drawing object is an image which is drawn by one drawing command of PDL data. PDL data indicates position information, format information, and color information concerning drawing objects. Examples of drawing objects are a character portion, a graphic portion, an image portion (continuous tone image, such as a photograph), and a form portion of a document.

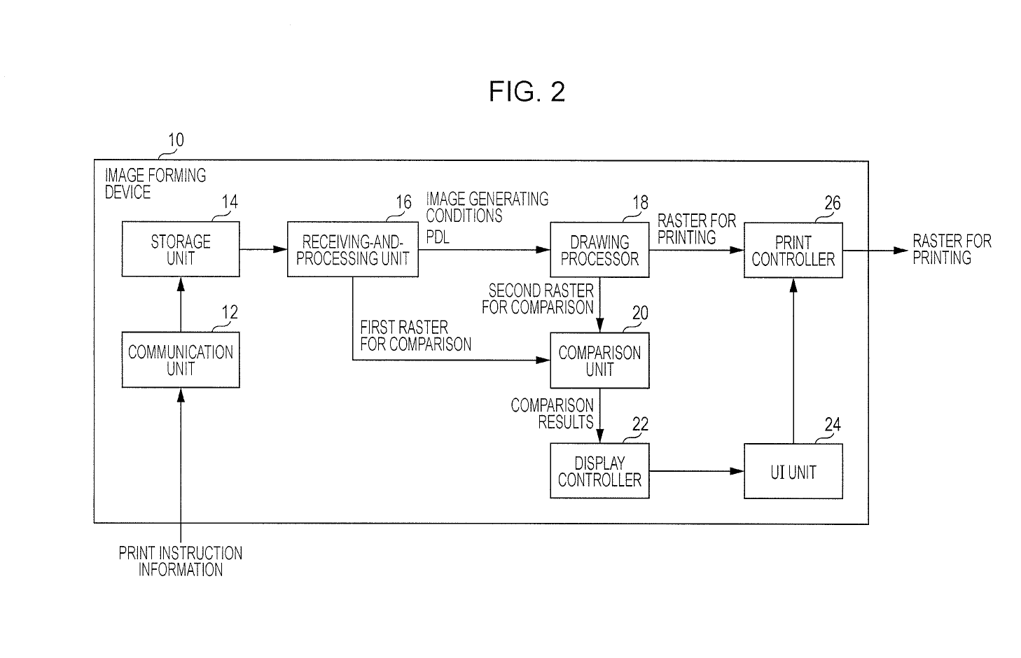

FIG. 2 illustrates an example of the image forming device 10.

A communication unit 12 is a communication interface connected to the communication channel N. The communication unit 12 has a function of receiving data from another device and a function of sending data to another device.

In this exemplary embodiment, the communication unit 12 receives print instruction information from the terminal device 40. The print instruction information includes PDL data indicating an image to be printed and information indicating image generating conditions for printing. If comparison processing for comparing items of image data is performed, the print instruction information also includes information indicating image generating conditions for comparison processing and image data generated by the terminal device 40. The comparison processing will be discussed later. Hereinafter, image data generated by the terminal device 40 will be referred to as “first raster data for comparison”. The first raster data for comparison is image data generated from the PDL data in accordance with the image generating conditions for comparison processing. The first raster data for comparison is data indicating information concerning individual pixels (pixel values) forming an image to be printed, and is, for example, bitmap data. Examples of the image generating conditions are a sheet size, image quality (for example, the resolution of an image), page orientation, color, and page range (pages to be printed).

A storage unit 14 is a storage device, such as a hard disk. In the storage unit 14, print instruction information is stored.

A receiving-and-processing unit 16 extracts PDL data and information indicating image generating conditions from print instruction information, and outputs the extracted PDL data and information indicating image generating conditions (corresponding to “PDL” and “image generating conditions”, respectively, in FIG. 2) to a drawing processor 18. The receiving-and-processing unit 16 also extracts first raster data for comparison from the print instruction information and outputs the first raster data for comparison (corresponding to “first raster for comparison” in FIG. 2) to a comparison unit 20.

The drawing processor 18 is a RIP. The drawing processor 18 converts PDL data into image data that is supported and handled by the printer 30 (raster data). The raster data is data indicating information concerning individual pixels (pixel values) forming an image to be printed, and is, for example, bitmap data.

When printing is performed, the drawing processor 18 converts PDL data into raster data in accordance with the image generating conditions for printing. Hereinafter, raster data generated in accordance with image generating conditions for printing will be referred to as “raster data for printing” (corresponding to “raster for printing” in FIG. 2). The drawing processor 18 outputs the raster data for printing to a print controller 26.

When comparison processing is performed, the drawing processor 18 converts PDL data into raster data in accordance with the image generating conditions for comparison processing. Hereinafter, raster data generated in accordance with image generating conditions for comparison processing will be referred to as “second raster data for comparison” (corresponding to “second raster for comparison” in FIG. 2). The drawing processor 18 outputs the second raster data for comparison to the comparison unit 20.

The comparison unit 20 compares the first raster data for comparison and the second raster data for comparison with each other, and outputs information indicating the comparison results to a display controller 22. The comparison unit 20 compares the first raster data for comparison and the second raster data for comparison according to the page. As a result of conducting this comparison, a portion and a page that may not be printed as intended by a user, that is, a portion and a page in which a printing failure may occur, are detected. If there is a difference between the first raster data for comparison and the second raster data for comparison, a printing failure caused by RIP processing may occur. If an image is actually printed, a portion (page) where the above-described difference is generated is not printed as intended by the user, that is, a printing failure may occur in this portion (page). The comparison unit 20 detects such a printing failure by comparing the first raster data for comparison and the second raster data for comparison with each other. After detecting a difference between the first raster data for comparison and the second raster data for comparison, the comparison unit 20 may output information indicating that a difference has been detected (difference detection information) to the display controller 22. If the difference is equal to or greater than a threshold, the comparison unit 20 may output alarming information to the display controller 22. The comparison unit 20 may output information indicating a page number in which a difference has been detected to the display controller 22. The comparison unit 20 may detect a difference between the first raster data for comparison and the second raster data for comparison and may output information indicating this difference to the display controller 22.

The display controller 22 causes a display of a user interface (UI) unit 24 to display various items of information. For example, the display controller 22 causes the display to display a list of items of print instruction information. The display controller 22 causes the display to display information indicating comparison results. If a difference between the first raster data for comparison and the second raster data for comparison is detected, the display controller 22 may cause the display to display difference detection information or alarming information or to display a page number in which this difference has been detected. The display controller 22 may also cause the display to display a difference detected by the comparison unit 20. The display controller 22 may also cause the display to display the first raster data for comparison and the second raster data for comparison side by side or by superposing them on each other.

The UI unit 24 includes an operating section and a display. The operating section is an input device, such as an operation panel. The display is a display device, such as a liquid crystal display.

The print controller 26 controls a printing operation performed by the printer 30. The print controller 26 outputs raster data for printing to the printer 30, and causes the printer 30 to perform printing in accordance with the image generating conditions for printing.

The image forming device 10 is implemented by, for example, the cooperation of hardware resources and software. More specifically, the image forming device 10 includes a processor (not shown), such as a central processing unit (CPU). This processor reads and executes a program stored in a storage unit (not shown), thereby implementing the functions of the individual elements of the image forming device 10. This program is stored in the storage unit via a recording medium, such as a compact disc (CD) or a digital versatile disc (DVD), or via a communication channel, such as a network. Alternatively, the individual elements of the image forming device 10 may be implemented by a hardware resource, such as a processor or an electronic circuit. In this case, a device, such as a memory, may be used. Alternatively, the individual elements of the image forming device 10 may be implemented by a digital signal processor (DSP) or a field programmable gate array (FPGA).

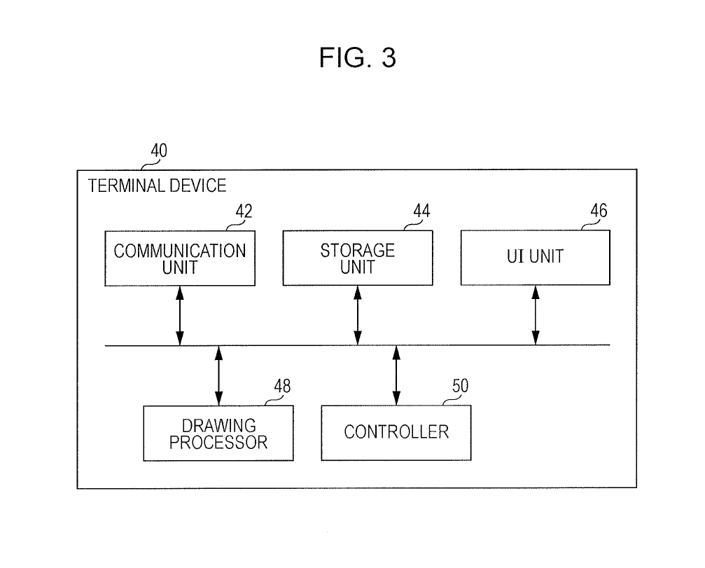

FIG. 3 illustrates an example of the terminal device 40. The terminal device 40 is, for example, a personal computer, a workstation, a smartphone, or a cellular phone.

A communication unit 42 is a communication interface connected to the communication channel N. The communication unit 42 has a function of receiving data from another device and a function of sending data to another device. In this exemplary embodiment, the communication unit 42 sends print instruction information to the image forming device 10.

A storage unit 44 is a storage device, such as a hard disk. In the storage unit 44, image data is stored, and PDL data and first raster data for comparison are also stored. In the storage unit 44, a printer driver is also stored. The printer driver is a program having a function of controlling the printer 30.

A UI unit 46 includes an operating section and a display. The operating section is an input device, such as an operation panel. The display is a display device, such as a liquid crystal display. For example, as a result of a user using the operating section, PDL data indicating an image to be printed, image generating conditions for printing, and image generating conditions for comparison processing are specified.

A drawing processor 48 generates raster data (first raster data for comparison) from PDL data indicating an image to be printed in accordance with image generating conditions for comparison processing.

In this case, the drawing processor 48 may first detect features of each of drawing objects represented by the raster data generated from the PDL data, and then may select a portion of the raster data that is handled as first raster data for comparison, on the basis of the detection results. For example, if PDL data indicates images of plural pages, the drawing processor 48 detects features of the drawing objects represented by the raster data of each of the pages. On the basis of the detection results, the drawing processor 48 then selects the first raster data for comparison from among plural items of raster data of the plural pages. More specifically, the drawing processor 48 detects edges (outlines) of the drawing objects as features. For example, the drawing processor 48 detects, as an edge, a portion at which the difference between the pixel values of two adjacent pixels is equal to or greater than a pixel threshold. Then, the drawing processor 48 selects raster data of a page in which the number of edges (the number of pixels considered to be edges) is equal to or greater than an edge threshold, as the first raster data for comparison. For example, concerning a character portion, the boundary of a character portion with a peripheral portion is relatively clear, and the difference between the pixel value of a pixel forming the character portion and that of the peripheral portion is likely to be equal to or greater than the pixel threshold. Accordingly, the number of edges in a page including relatively many characters is likely to be equal to or greater than the edge threshold, and raster data of this page is likely to be selected as the first raster data for comparison. Additionally, the number of edges included in a relatively complicated drawing object is likely to be equal to or greater than the edge threshold. Accordingly, raster data of a page including a relatively complicated drawing object is also likely to be selected as the first raster data for comparison. The pixel threshold and the edge threshold may be preset, or may be changed to desired values by the user or the operator.

A controller 50 controls the operations of the individual elements of the terminal device 40. The controller 50 generates print instruction information. The print instruction information includes PDL data indicating an image to be printed and information indicating image generating conditions for printing. If comparison processing is performed, the print instruction information also includes information indicating image generating conditions for comparison processing and first raster data for comparison.

The terminal device 40 is implemented by, for example, the cooperation of hardware resources and software. More specifically, the terminal device 40 includes a processor (not shown), such as a CPU. This processor reads and executes a program stored in a storage unit (not shown), thereby implementing the functions of the individual elements of the terminal device 40. This program is stored in the storage unit via a recording medium, such as a CD or a DVD, or via a communication channel, such as a network. Alternatively, the individual elements of the terminal device 40 may be implemented by a hardware resource, such as a processor or an electronic circuit. In this case, a device, such as a memory, may be used. Alternatively, the individual elements of the terminal device 40 may be implemented by a DSP or a FPGA.

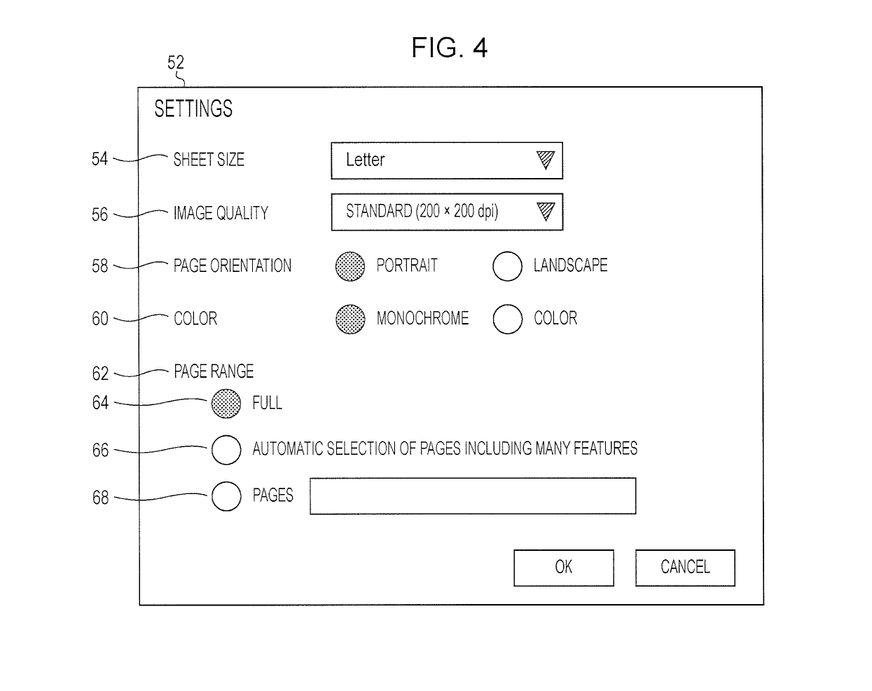

FIG. 4 illustrates an example of a screen 52 for setting image generating conditions. The screen 52 is a screen of the display of the UI unit 46 of the terminal device 40. On the screen 52, items for setting image generating conditions are displayed. In the example shown in FIG. 4, items for setting image generating conditions for comparison processing are displayed. Examples of the items are a sheet size 54, an image quality 56 (the resolution of images), a page orientation 58, a color 60, and a page range 62. As the sheet size 54, the sheet size used for printing is specified. As the image quality 56 for comparison processing, the lower resolution than that for normal printing is specified. For example, if the image quality for normal printing is “1200×1200 dpi”, “200×200 dpi” is specified as the image quality 56 for comparison processing. By setting the image quality for comparison processing to be lower than that for normal printing, the amounts of first raster data for comparison and the second raster data for comparison can be reduced, and it is possible to perform comparison processing with a smaller amount of data, compared with a case in which the image quality for comparison processing is the same as that for normal printing. Additionally, since the amount of data to be sent from the terminal device 40 to the image forming device 10 is decreased, the time taken to perform transfer processing is reduced. A low-resolution image is assumed to be suitable for detecting the misregistration of character strings or the garbling of characters. It is noted that a default image quality may be set in advance. As the page orientation 58, portrait or landscape is selected. As the color 60, monochrome (black and white) or color (for example, full color) is selected. As the page range 62, pages to be subjected to comparison processing are specified. An item 64 is an item for specifying raster data of all pages represented by PDL data as first raster data for comparison. When the item 64 is selected, raster data of all pages is selected as the first raster data for comparison. An item 66 is an item for automatically selecting raster data of pages for which more features have been detected as the first raster data for comparison. More specifically, the item 66 is an item for selecting raster data of pages in which the number of edges is equal to or greater than the edge threshold, as the first raster data for comparison. When the item 66 is selected, raster data of pages in which the number of edges is equal to or greater than the edge threshold is automatically selected as the first raster data for comparison. An item 68 is an item for specifying a page number. When the item 68 is selected and a page number is input, raster data of this page number is selected as the first raster data for comparison. Conditions specified on this screen 52, for example, by the user, are set to be image generating conditions for comparison processing. In the example shown in FIG. 4, “Letter” is specified as the sheet size 54, “200×200 dpi” is specified as the image quality 56, “portrait” is selected as the page orientation 58, “monochrome” is selected as the color 60, and the item 64 (full) is selected as the page range 62. The conditions to be specified are not restricted to those in FIG. 4, and other conditions may be specified. Among plural conditions, at least one condition may be specified.

Image generating conditions for printing may also be specified by the terminal device 40. For example, the user refers to the setting screen displayed on the display of the UI unit 46 and specifies image generating conditions for printing by using the operating section of the UI unit 46. As in the settings of the image generating conditions for comparison processing, the sheet size, image quality, page orientation, color, and page range are specified. PDL data of an image to be printed is also specified by the user.

When the image generating conditions for comparison processing are specified, as described above, the drawing processor 48 of the terminal device 40 converts PDL data of an image to be printed into first raster data for comparison in accordance with the image generating conditions.

When the PDL data of an image to be printed and image generating conditions for printing are specified, the controller 50 of the terminal device 40 generates print instruction information including the PDL data and information indicating the image generating conditions for printing. When the image generating conditions for comparison processing are specified, the controller 50 generates print instruction information including the PDL data, information indicating the image generating conditions for printing, information indicating the image generating conditions for comparison processing, and first raster data for comparison. The generated print instruction information is sent from the terminal device 40 to the image forming device 10.

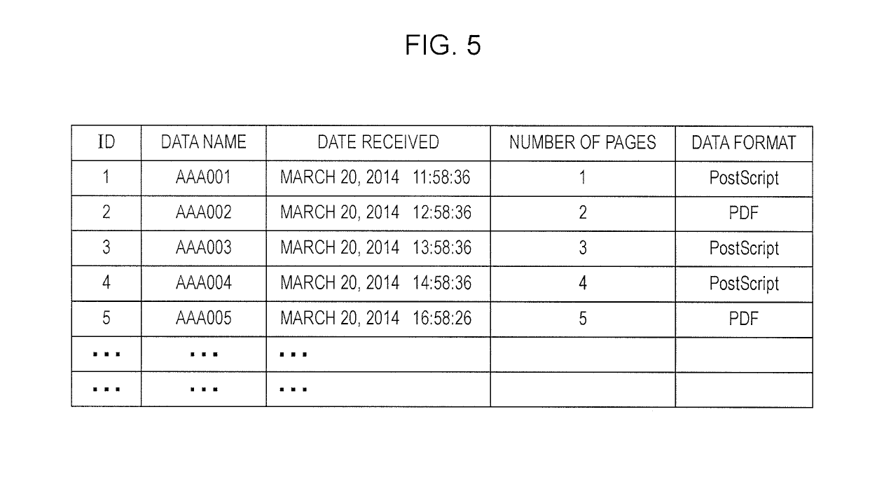

FIG. 5 illustrates an example of a list of items of print data. Print instruction information sent from the terminal device 40 to the image forming device 10 is temporarily stored in the storage unit 14 of the image forming device 10. The list shown in FIG. 5 is a list of items of the print instruction information. The list includes, for example, a job ID, a data name of PDL data, a date received, the number of pages included in PDL data, and a format of PDL data (data format). Other items of information may be included in the list.

In the image forming device 10, the display controller 22 refers to items of print instruction information stored in the storage unit 14, and causes the display of the UI unit 24 to display a list of the items of print instruction information. Then, the user or the operator specifies PDL data to be subjected to comparison processing from the list by using the operating section of the UI unit 24 so as to instruct the drawing processor 18 to perform comparison processing. Then, the drawing processor 18 generates second raster data for comparison. Then, the comparison unit 20 compares the first raster data for comparison and the second raster data for comparison with each other. The display controller 22 causes the display of the UI unit 24 to display the comparison results. When the user specifies PDL data of an image to be printed and gives a print instruction, the print controller 26 outputs raster data for printing generated from the specified PDL data to the printer 30, and causes the printer 30 to perform printing in accordance with the image generating conditions for printing.

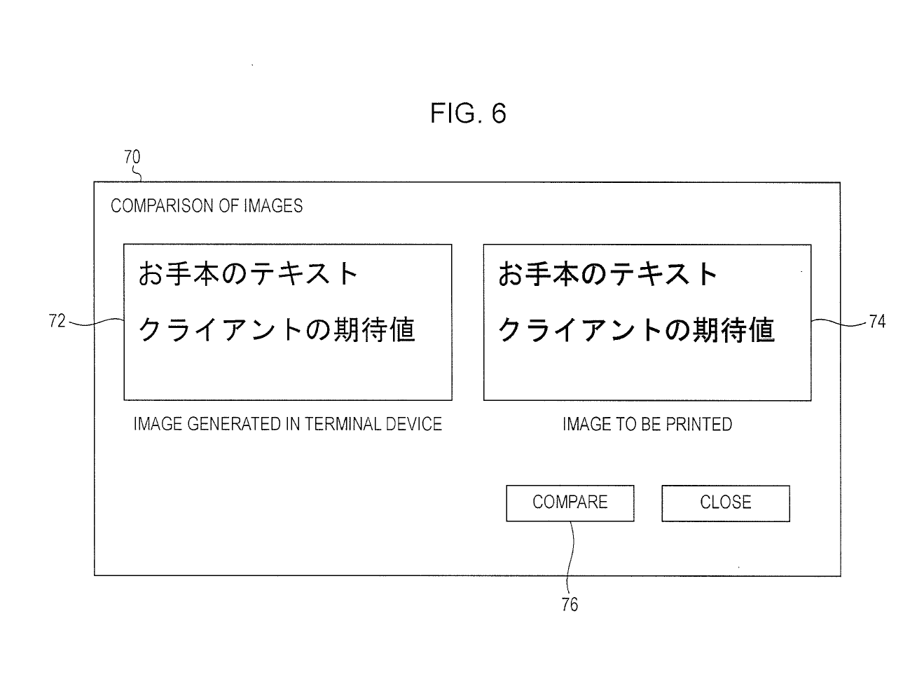

FIG. 6 illustrates an example of a screen 70 on which images for comparison are displayed. The screen 70 is a screen of the display of the UI unit 24 of the image forming device 10. On this screen 70, images 72 and 74 are displayed side by side. The image 72 is an image based on the first raster data for comparison generated by the drawing processor 48 of the terminal device 40. The image 74 is an image based on the second raster data for comparison generated by the drawing processor 18 of the image forming device 10. The images 72 and 74 are images generated in accordance with the same image generating conditions for comparison processing.

The user or the operator compares the images 72 and 74 displayed on the screen 70 and checks differences therebetween. For example, it is assumed that the image 72 generated by the terminal device 40 is an image intended by the user. In this case, by comparing the images 72 and 74 with each other, the user or the operator checks whether or not the image intended by the user has been generated in the image forming device 10. For example, it is assumed that the user or the operator compares the images 72 and 74 in terms of the misregistration and the hue. If the differences between the images 72 and 74 are within the acceptable range, the user or the operator may give an instruction to start printing. In response to this instruction, the drawing processor 18 converts PDL data into raster data for printing in accordance with the image generating conditions for printing, and the print controller 26 outputs the raster data for printing to the printer 30. Then, an image based on the raster data for printing is formed on a recording medium by the printer 30. On the other hand, if the user or the operator determines that the differences between the images 72 and 74 are not within the acceptable range, the user or the operator does not give an instruction to start printing. In this case, the user or the operator adjusts the image generating conditions so as to generate new print instruction information.

On the screen 70, a button 76 for giving an instruction to perform comparison processing is displayed. If the user or the operator presses the button 76 by using the operating section of the UI unit 24, the comparison unit 20 detects differences between the images 72 and 74. The display controller 22 causes the display to display the detection results.

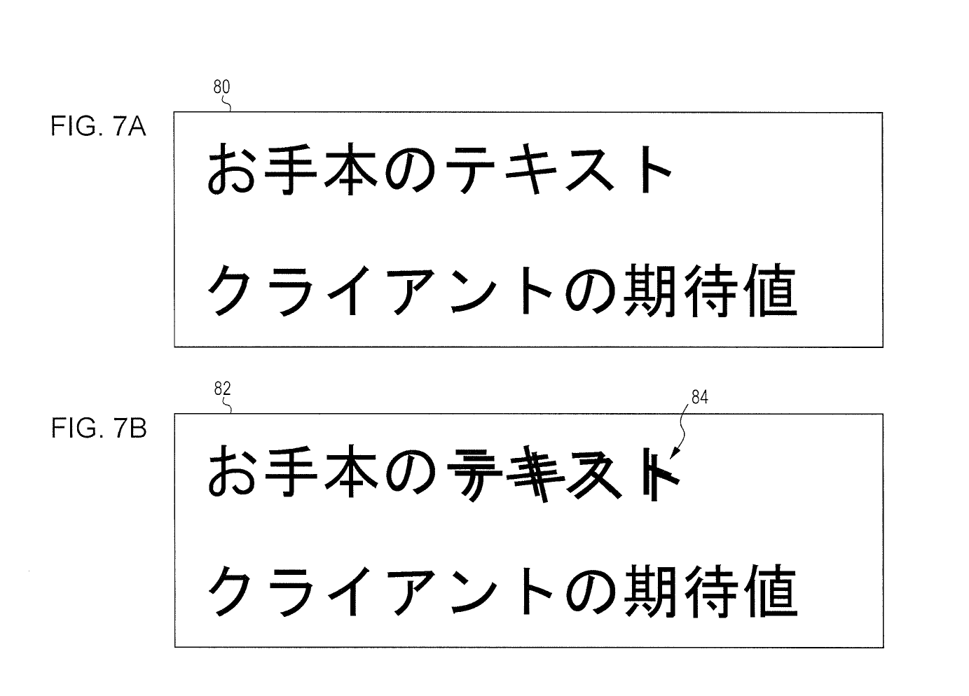

If the button 76 is pressed, the display controller 22 may cause the display to display the images 72 and 74 by superposing them on each other. FIGS. 7A and 7B illustrate examples of the images 72 and 74 superposed on each other. An image 80 shown in FIG. 7A and an image 82 shown in FIG. 7B are images obtained as a result of superposing the images 72 and 74. The image 80 is an image obtained when there is no difference between the images 72 and 74. The image 82 is an image obtained when there are differences between the images 72 and 74. In the image 82, there are differences between the images 72 and 74 at a portion 84, and more specifically, the misregistration of characters occurs at the portion 84. By referring to the image 82, the user or the operator can check the portion 84 in which differences between the images 72 and 74 occur. The misregistration of characters may be due to a quantization error when RIP processing is performed, or may be due to another reason.

The comparison unit 20 may detect the portion 84 at which differences between the images 72 and 74 occur, and the display controller 22 may cause the display to display the portion 84 only. This also enables the user or the operator to check the portion 84 at which differences occur. If the differences are equal to or greater than a threshold, alarming information may be displayed on the display.

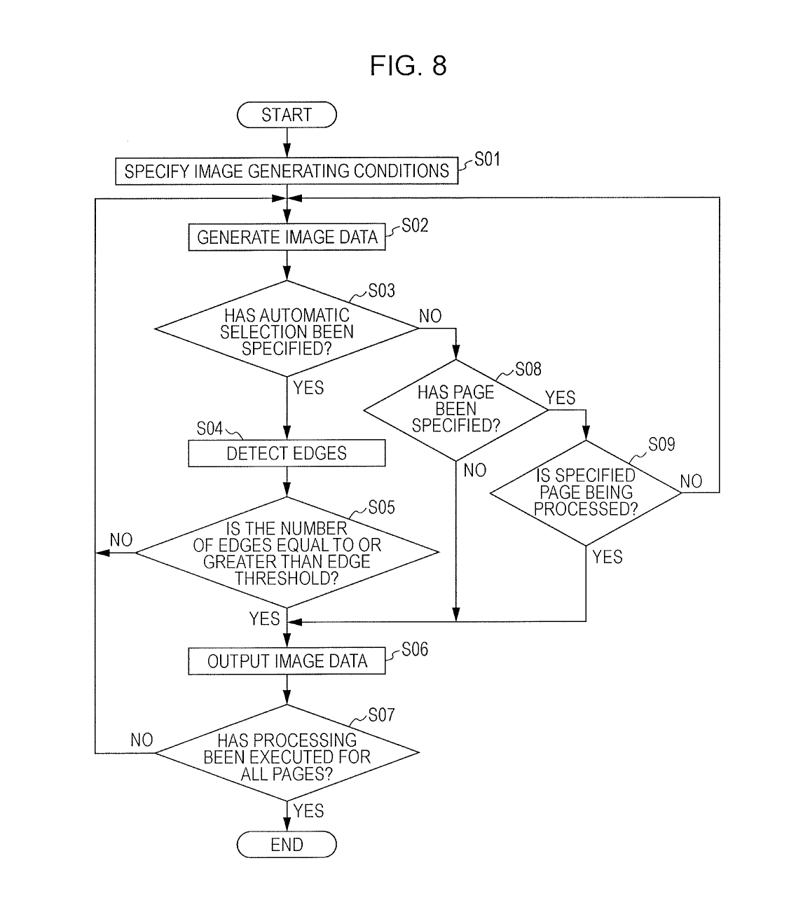

An example of processing executed in the terminal device 40 will be described below with reference to the flowchart of FIG. 8. In step S01, a user or an operator specifies PDL data of an object to be printed and image generating conditions by using the UI unit 46 of the terminal device 40. For example, the screen 52 shown in FIG. 4 is displayed on the display of the terminal device 40, and the user specifies image generating conditions for comparison processing and image generating conditions for printing on this screen 52. Information indicating the image generating conditions for printing and information indicating the image generating conditions for comparison processing are temporarily stored in the storage unit 44.

Then, in step S02, the drawing processor 48 of the terminal device 40 converts the PDL data into raster data based on each page. For example, raster data of the first page is generated. Then, it is determined in step S03 whether or not automatic selection for raster data has been specified as an image generating condition, that is, whether or not the item 66 shown in FIG. 4 has been selected. If the item 66 has been selected, the process proceeds to step S04. In step S04, the drawing processor 48 detects edges (outlines) from the generated raster data (for example, the raster data of the first page), and counts the number of detected edges. It is then determined in step S05 whether or not the counted number of edges is equal to or greater than the edge threshold. If the result of step S05 is YES, the process proceeds to step S06. In step S06, the drawing processor 48 outputs the generated raster data (for example, the raster data of the first page) as first raster data for comparison. The first raster data for comparison is temporarily stored in the storage unit 44. With this operation, raster data of a page including relatively many characters or raster data of a page including a relatively complicated drawing object is output as the first raster data for comparison. It is then determined in step S07 whether or not steps S02 through S06 have been executed for all pages included in the PDL data. If the result of step S07 is YES, the processing executed in the terminal device 40 has been completed. If it is determined in step S07 that not all pages have been subjected to step S02 through S06, the process returns to step S02. Then, steps S02 through S06 are executed for the raster data of the subsequent page (for example, the second page). If it is determined in step S05 that the number of edges is smaller than the edge threshold, the generated raster data (for example, the raster data of the first page) is not output as the first raster data for comparison. In this case, the process returns to step S02, and steps S02 through S06 are executed for the raster data of the subsequent page.

If it is determined in step S03 that automatic selection for raster data has not been specified as an image generating condition, the process proceeds to step S08 to determine whether or not a page has been specified as an image generating condition, that is, whether or not the item 64 shown in FIG. 4 has been selected. If it is determined in step S08 that no page has been specified, that is, if the item 64 shown in FIG. 4 has been selected, the process proceeds to step S06. In step S06, the drawing processor 48 outputs the generated raster data (for example, the raster data of the first page) as first raster data for comparison. If the item 64 has been selected, it means that all pages are specified as the first raster data for comparison. Accordingly, the generated raster data is output as the first raster data for comparison and is temporarily stored in, for example, the storage unit 44.

If it is determined in step S08 that a page has been specified as an image generating condition, that is, if the item 68 shown in FIG. 4 has been selected and a page number has been specified, the process proceeds to step S09. It is determined in step S09 whether or not the page which is being processed by the drawing processor 48 (for example, the first page) is a specified page. If the result of step S09 is YES, the process proceeds to step S06. In step S06, the drawing processor 48 outputs the generated raster data (for example, the raster data of the first page) as the first raster data for comparison. The first raster data for comparison is temporarily stored in the storage unit 44. If it is determined in step S09 that the page which is being processed by the drawing processor 48 (for example, the first page) is not a specified page, the generated raster data (for example, the raster data of the first page) is not output as the first raster data for comparison. In this case, the process returns to step S02 and steps S02 through S06 are executed for the raster data of the subsequent page.

If it is determined in step S07 that steps S02 through S06 have been executed for all pages included in the PDL data, the processing executed in the terminal device 40 has been completed.

Upon the completion of the processing, the controller 50 of the terminal device 40 generates print instruction information including the PDL data, information indicating the image generating conditions for printing, information indicating the image generating conditions for comparison processing, and the first raster data for comparison. Then, the communication unit 42 of the terminal device 40 sends the print instruction information to the image forming device 10.

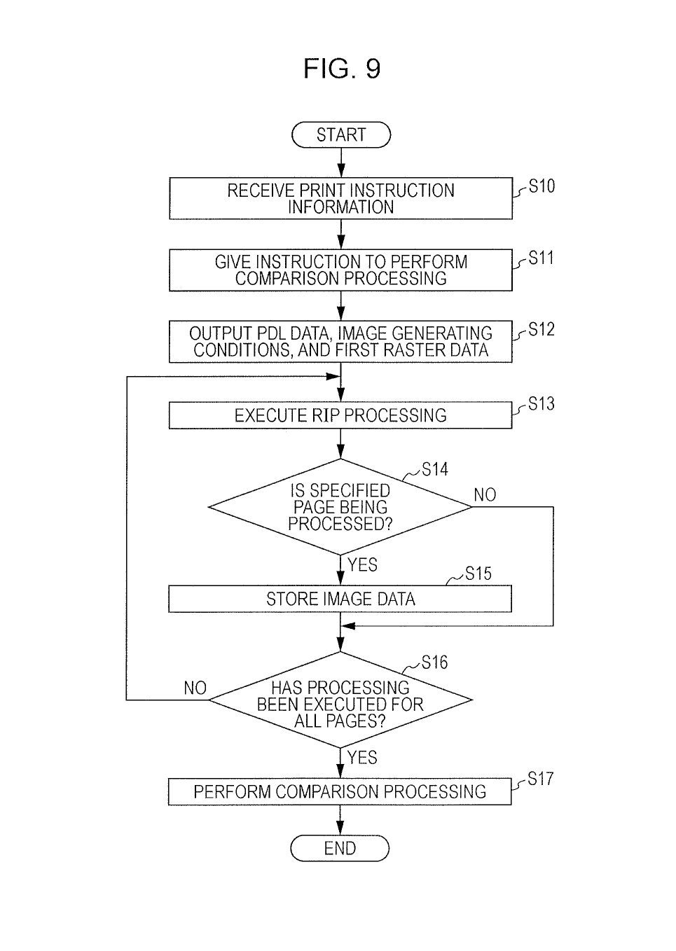

An example of processing executed in the image forming device 10 will be described below with reference to the flowchart of FIG. 9. In step S10, the communication unit 12 of the image forming device 10 receives print instruction information sent from the terminal device 40. The print instruction information is temporarily stored in the storage unit 14. The display controller 22 causes the display of the UI unit 24 to display a list of items of print instruction information stored in the storage unit 14. Then, in step S11, by using the operating section of the UI unit 24, the user or the operator specifies PDL data used for comparison processing so as to give an instruction to perform comparison processing. Then, the comparison processing is performed as follows.

In step S12, the receiving-and-processing unit 16 obtains print instruction information concerning the specified PDL data from the storage unit 14. Then, the receiving-and-processing unit 16 extracts the PDL data and the information indicating image generating conditions for comparison processing from the print instruction information, and outputs them to the drawing processor 18. The receiving-and-processing unit 16 also extracts first raster data for comparison from the print instruction information and outputs it to the comparison unit 20.

In step S13, the drawing processor 18 executes RIP processing for the raster data based on each page. That is, the drawing processor 18 converts the PDL data into raster data based on each page in accordance with the image generating conditions for comparison processing, thereby generating second raster data for comparison, for example, second raster data for comparison of the first page.

It is then determined in step S14 whether or not the page (for example, the first page) which is being processed by the drawing processor 18 is a page specified by the image generating condition for comparison processing. If the result of step S14 is YES, the process proceeds to step S15. In step S15, the drawing processor 18 temporarily stores the generated second raster data for comparison (for example, the first page) in the storage unit 14. On the other hand, if it is determined in step S14 that the page which is being processed by the drawing processor 18 is not a specified page, the process proceeds to step S16. In this case, the generated second raster data for comparison is not used for comparison processing, and is, for example, deleted. The specified page is a page to be subjected to comparison processing, and is a page specified by one of the items 64, 66, and 68 shown in FIG. 4. If the item 64 is selected, all pages are specified as pages to be subjected to comparison processing. If the item 66 is selected, pages in which the number of edges is equal to or greater than the edge threshold are specified pages. If the item 68 is selected and a page number is specified, the page of the specified number is a specified page. If the page which is being processed by the drawing processor 18 is a page specified for comparison processing, the second raster data for comparison of this page is temporarily stored in the storage unit 14 and is used for comparison processing.

Then, it is determined in step S16 whether or not steps S13 and S14 have been executed for all pages included in the PDL data. If the result of step S16 is YES, the process proceeds to step S17. If it is determined in step S16 that not all pages have been subjected to steps S13 and S14, the process returns to step S13. Then, steps S13 and S14 are executed for the subsequent page (for example, the second page).

In step S17, the first raster data for comparison and the second raster data for comparison are compared with each other. For example, as shown in FIG. 6, the display controller 22 causes the display of the UI unit 24 to display the image 72 based on the first raster data for comparison and the image 74 based on the second raster data for comparison side by side. The images of the first raster data for comparison and the second raster data for comparison are displayed side by side according to the page. Alternatively, as shown in FIGS. 7A and 7B, the display controller 22 may display the images 72 and 74 by superposing them on each other. The comparison unit 20 may detect differences between the images 72 and 74. In this case, difference detection information or alarming information may be displayed on the display.

As described above, in this exemplary embodiment, first raster data for comparison generated by the terminal device 40 and second raster data for comparison generated by the image forming device 10 are compared with each other and are displayed. This makes it possible to check a portion and a page that may not be printed as intended by the user, that is, a portion and a page in which a printing failure may occur.

If printing is performed by skipping comparison processing, the user or the operator may specify data of an image to be printed from a list of items of print instruction information and give an instruction to perform printing. Then, the image represented by the specified data is printed by the printer 30.

A mark may be formed on a page to be subjected to comparison processing. Then, the terminal device 40 and the image forming device 10 may specify a page to be subjected to comparison processing on the basis of this mark, and respectively generate first raster data for comparison and second raster data for comparison of the specified page.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming device comprising:
a receiver that receives, from an external device, print instruction information including print data described in a page description language and a first image generated from the print data by the external device;
a generator that generates a second image from the print data included in the print instruction information; and
a controller that compares the first image and the second image with each other and causes a display to display misregistration of the first image and the second image as a comparison result.

2. The image forming device according to claim 1, wherein:
the print instruction information further includes information indicating a generating condition for generating the first image; and
the generator generates the second image in accordance with the generating condition.

3. The image forming device according to claim 2, wherein:
the generating condition indicates a page for which the first image has been generated among a plurality of pages represented by the print data; and
a page for which the first image has been generated has been determined on the basis of a feature of a drawing object represented by the print data.

4. The image forming device according to claim 1, wherein a resolution of the first image and the second image is lower than a resolution used for printing of the print data.

5. An image forming method comprising:
receiving, from an external device, print instruction information including print data described in a page description language and a first image generated from the print data by the external device;
generating a second image from the print data included in the print instruction information; and
comparing the first image and the second image with each other and causing a display to display misregistration of the first image and the second image as a comparison result.

6. A non-transitory computer readable medium storing a program causing a computer to execute a process, the process comprising:
receiving, from an external device, print instruction information including print data described in a page description language and a first image generated from the print data by the external device;
generating a second image from the print data included in the print instruction information; and
comparing the first image and the second image with each other and causing a display to display misregistration of the first image and the second image as a comparison result.
